(19) United States
(12) Patent Application Publication
(10) Pub. No.: US 2005/0039964 A1
(43) Pub. Date: Feb. 24, 2005

(54) Hybrid vehicle

(76) Inventor: Louis Goyry, Lacolle (CA)

Correspondence Address: Eric Fincham, 316 Knowlton Road, Lac Brome, QC, J0E 1V0, CA

(21) Appl. No.: 10/869,384

(22) Filed: Jun. 16, 2004

(30) Foreign Application Priority Data
Aug. 19, 2003 (CA) 2,437,632

(51) Int. Cl. B60K 6/04

(52) U.S. Cl. 180/243; 180/65.2; 180/68.5

(57) ABSTRACT

Improvements in a hybrid vehicle using an internal combustion engine and an electric propulsion, the improvement comprising the arrangement wherein there is a rear section which comprises a rear axle, wheels mounted on the rear axle, a platform mounted on the axle, and wherein the platform has a weight distribution whereby greater than 50% of the weight of the platform is located rearwardly of the rear axle and the platform is tilted with respect to the horizontal.

### FIELD OF THE INVENTION

The present invention relates to hybrid vehicles and more particularly, relates to hybrid vehicles having both an internal combustion engine and electric propulsion means.

### BACKGROUND OF THE INVENTION

Hybrid vehicles are well known in the art. There have been many proposals for different types of hybrid vehicles which combine both an internal combustion engine and electrical propulsion means as power sources for driving the vehicle wheels. Among the various proposals is what is known as a series type of hybrid vehicle which is driven by electric motors with the electrical power being generated by an internal combustion engine. Another type of hybrid vehicle is what is known as the parallel type wherein the wheels are driven by both an internal combustion engine and an electric motor with the electrical power drawn from batteries and not from the internal combustion engine. There have also been other different combinations of driving means which have been proposed in the art. The major differences between the compound type hybrid vehicles generally relate to their layout of the power train and design or control strategy thereof.

Thus, one compound type of hybrid vehicle uses a driving motor, an internal combustion engine and a generator connected to a differential gear. With this type of arrangement, the vehicle is generally started from a stopped state by the electric motor with the internal combustion engine cutting in when it is driven at a specific vehicle speed.

There are also proposals for a vehicle control system which control the optimal operating points with respect to the two different sources of power.

To date, hybrid vehicles have not been accepted by the motoring public to any great degree. It is believed that this is the result of deficiencies in the vehicle when compared to conventional vehicles powered solely by an internal combustion engine. Two problems arise, particularly in North American society. The first one is the range of the vehicle and in this respect, the range of electrical vehicles is limited. This does not fit in with the driving habits of the typical motorist who frequently must drive sufficiently long distances which are beyond the capacity of the electric vehicle.

A further problem which occurs is the lack of power of such vehicles. Thus, while some of the vehicles are suitable for use in an urban environment where high speed is not a requirement, they are not able to satisfy the demand for highway speeds and passing ability.

### SUMMARY OF THE INVENTION

It is therefore an object of the present invention to provide a hybrid vehicle suitable for use in both urban and rural environments.

It is a further object of the present invention to provide a hybrid vehicle which is relatively inexpensive, and can respond to most motoring needs.

It is a further object of the present invention to provide a vehicle having a trailer portion forming a rear of the vehicle and which trailer portion is connected to the frame of the vehicle.

According to one aspect of the present invention there is provided a method of operating a motor vehicle wherein the vehicle has an internal combustion engine and electrical propulsion means, the electrical propulsion means being associated with driving a first set of driving wheels and the internal combustion engine being associated with a second set of driving wheels, the method comprising the steps of using both the internal combustion engine and the electrical propulsion means for driving the vehicle from rest to a first predetermined speed, and using only the internal combustion engine when the vehicle has passed the first predetermined speed.

According to a further aspect of the present invention there is provided a hybrid vehicle having an internal combustion engine operative to drive a first set of driving wheels and electric propulsion means operative to drive a second set of driving wheels, the improvement comprising control means operative to supply power from the electrical propulsion means when the vehicle is accelerated from a position of rest to a predetermined speed, and subsequently cuts power from the electrical propulsion means when the predetermined speed has been exceeded.

According to a still further aspect of the present invention, in a vehicle having a frame, a body secured to the frame, propulsion means, a front axle having wheels mounted thereon, the improvement wherein there is provided a rear section connected to the frame, the rear section comprising a rear axle, wheels mounted on the rear axle, a platform mounted on the axle, the platform having a weight distribution whereby greater than 50% of the weight of the platform is located rearwardly of the rear axle.

According to the present invention, the hybrid vehicle utilizes a control strategy wherein the electrical propulsion means and the internal combustion engine are both used to power the vehicle from a position of rest to a predetermined speed. Once the predetermined speed has been reached, the electric propulsion means are switched off and the vehicle is driven solely by the internal combustion engine. This arrangement permits the vehicle to be powered by a substantially smaller internal combustion engine as compared to present requirements for a vehicle which is powered solely by the internal combustion engine.

The vehicle of the present invention is also characterized by having wheels which are driven by different propulsion means. Thus, according to the preferred embodiments of the present invention, a first set of wheels, which may be the front wheels of the vehicle, are driven by the internal combustion engine while the rear wheels are driven by the second propulsion means and preferably the electric propulsion means.

In one embodiment of the invention, the electric propulsion means comprises two different motors, one responsible for each of the wheels driven by the electrical propulsion means. Such an arrangement simplifies the mechanical requirements of the vehicle as one does not require a differential. Rather, preferably each of the wheels driven by the electrical propulsion means is completely independent of the other including independent suspensions. The use of electric motors for driving a specific wheel is known in the art and need not be elaborated on herein.

The internal combustion engine may be any suitable, but will generally be characterized by having a substantially lower displacement than presently utilized combustion engines. It sufficies to say that such engines are well known in the art and many such internal combustion engines could be utilized in practice of the present invention.

Preferably, the present invention utilizes a control system such that all the power requirements for devices, apart from the direct propulsion of the vehicle, are provided by the batteries utilized in the vehicle. Thus, any power steering, power brakes, air conditioning, electrical accessories and the like are always operated by the batteries. The internal combustion engine is responsible solely for providing the propulsion for the vehicle.

In a preferred aspect of the invention, and as set forth above, there is provided a rear section which includes a rear axle, wheels mounted on the rear axle, a platform mounted on the axle, a platform having a weight distribution whereby greater than 50% of the weight on the platform is located rearwardly of the rear axle.

The rear section is connected to the frame and is preferably connected in a manner such that there is at least a limited movement through a vertical direction. The particular types of connection and joints can be any of those well known in the art.

The platform of the rear section is preferably utilized for carrying the batteries for a hybrid vehicle having electrical propulsion means. As discussed above, the batteries are preferably arranged such that the weight distribution is one wherein there is greater than 50% of the weight located rearwardly of the rear axle.

The precise arrangement of wheels and the like may be any desired and conventional. Similarly, the rear section is preferably provided with suspension means, the suspension means being interposed between the rear axle and the platform. Such suspension means may include, without limitation, conventional springs such as leaf and coil springs. Additionally, there may be provided conventional shock absorber means.

The control for the various components and operation of the vehicle is within the scope of those knowledgeable in the art. Thus, for example, reference may be had to U.S. Pat. Nos. 4,533,011; 5,713,425; 5,927,416 and other similar patents which show various types of control systems. Still a further type of control is shown in the teachings of U.S. Pat. No. 6,570,266.

The rear section of the vehicle, as aforementioned, is such that the weight distribution is one wherein greater than 50% of the weight is located rearwardly of the rear axle. As previously mentioned, this can be arranged in several different manners. However, in a conventional automotive type of vehicle, preferably the weight difference between the rear portion and front portion (the axle being considered midpoint) is between 100 and 400 pounds and more preferably, is between 150 and 200 pounds.

In the instance wherein the weight is evenly distributed over the whole platform, this can be accomplished by having the offset from the centerline or axle being in the area of 2 to 6 inches.

The rear section is connected to the frame, as aforementioned, such that tilted movement can be achieved. Conveniently, this can be achieved by a piano type hinge being located along two frame members. In such an arrangement, the angle of the rear platform is slightly tilted from the horizontal. Preferably, the angle would be between 10° and 20° and more preferably, between 15° and 17°.

### BRIEF DESCRIPTION OF THE DRAWINGS

Having thus generally described the invention, reference will be made to the accompanying drawings illustrating an embodiment thereof, in which:

FIG. 1 is a side elevational view of a portion of a vehicle with the shell of the vehicle shown in doted lines;

FIG. 2 is a top plan view of a trailer portion carrying the batteries for the electric propulsion means;

FIG. 3 is a side elevational view thereof, and

FIG. 4 is a view similar to FIG. 2 illustrating an alternative embodiment.

### DESCRIPTION OF THE PREFERRED EMBODIMENTS

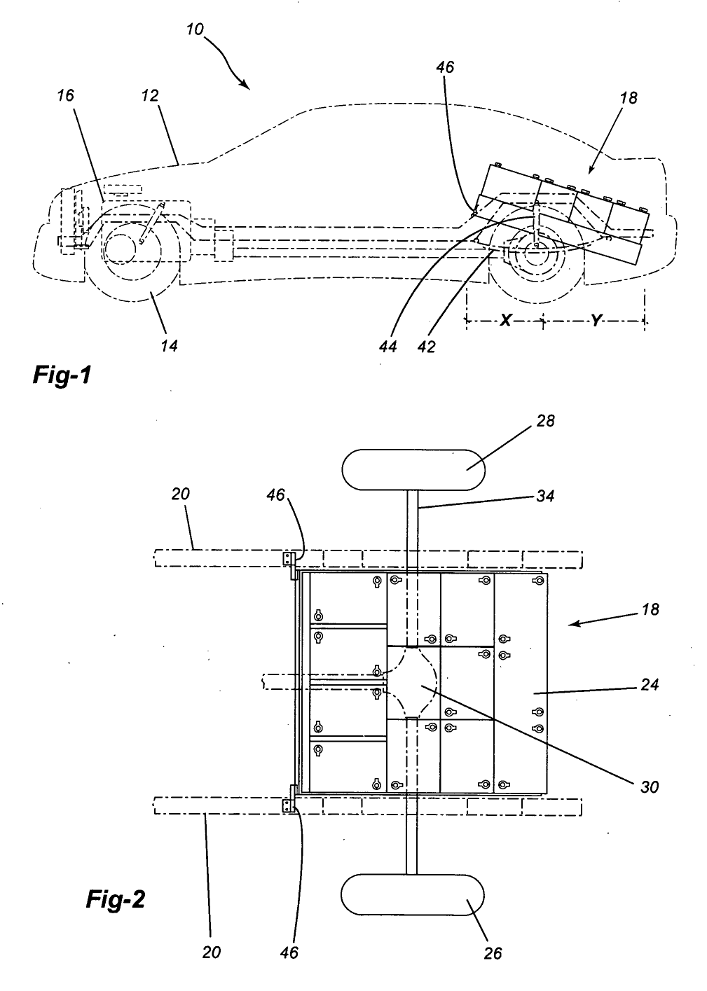

Referring to the drawings in greater detail and by reference characters thereto, there is illustrated in FIG. 1 a vehicle generally designated by reference numeral 10 in which has a body 12 shown in phantom. Vehicle 10 includes front wheels 14 which are driven by an internal combustion engine 16 in a conventional manner.

According to the present invention, there is provided a rear section 18 which comprises a frame 20 in which there is a platform 22.

A plurality of batteries 24 are mounted on platform 22 and are operatively connected through control mean (not shown) to drive an electric motor 30 which drives rear wheels 26, 28. The rear platform is provided with a conventional spring arrangement 42 with shock absorber 44.

In the arrangement illustrated in FIG. 4, frame 20 is of a slightly different configuration. In each case, however, a hinge arrangement is utilized for joining frame portion 20 to the main frame of the body. For securing the frame 20 of rear section 18 to the frame of the vehicle, a different arrangement may be provided. In one such arrangement, the frame of the rear section 18 may be secured to a vertical frame member and a horizontal frame member which in turn is secured to a vehicle horizontal frame member. The means of securement would be a hinge type 46 of arrangement. Thus, for example, a piano type hinge could be utilized.

Also, in the arrangement shown in FIG. 4, electric motors 36 and 38 are associated with wheels 26 and 28 respectively. Each electric motor 36 and 38 drives a single wheel as is known in the art.

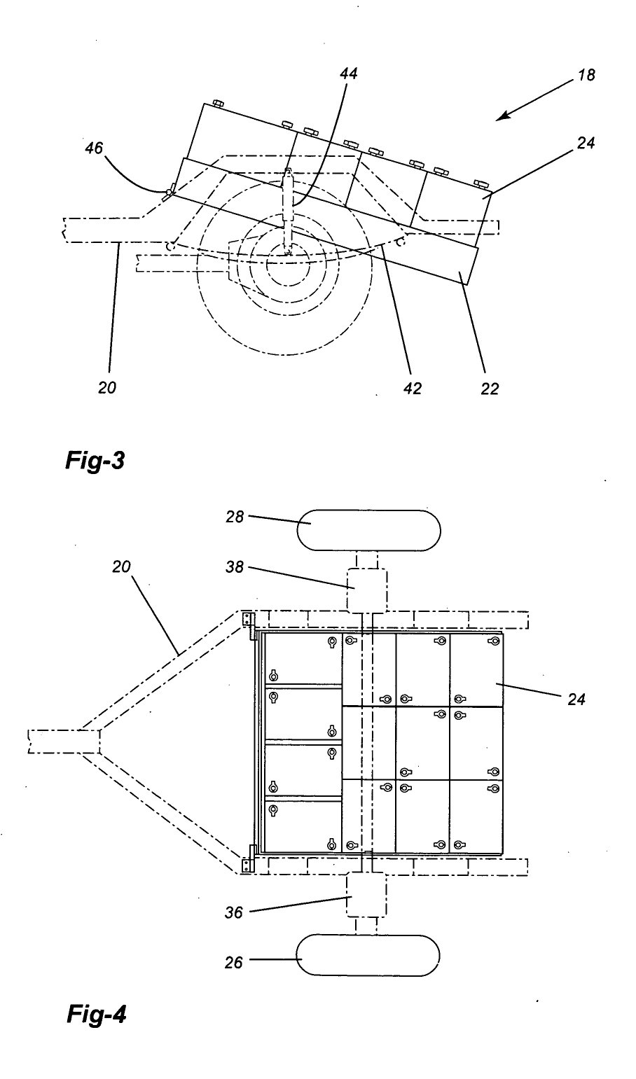

As may be seen in FIGS. 1 and 3, the arrangement is such that the platform 22 is tilted with respect to the horizontal, preferably at an angle of between 15° and 17°.

As may be seen in FIG. 1, the arrangement is such that from the axle 34 rearwardly there is a distance Y which is greater than distance X which covers the distance between the axle and the front of platform 22. In this arrangement, there is thus provided a greater weight rearwardly of the rear axle 34. Naturally, it will be understood that the distances do not have to be different; other arrangements can be utilized where the weight distribution is still greater to the rear of the platform.

It will be understood that the above described embodiment is for purposes of illustration only and that changes and modifications may be made thereto without departing from the spirit and scope of the invention.

1. A method of operating a motor vehicle wherein the vehicle has an internal combustion engine and electrical propulsion means, said electrical propulsion means being associated with driving a first set of driving wheels and said internal combustion engine being associated with a second set of driving wheels, the method comprising the steps of using both said internal combustion engines and said electrical propulsion means for driving the vehicle from rest to a first predetermined speed, and using only said internal combustion engines when said vehicle has passed said predetermined speed.

2. In a hybrid vehicle having an internal combustion engine operative to drive a first set of driving wheels and electric propulsion means operative to drive a second set of driving wheels, the improvement comprising control means operative to supply power from said electrical propulsion means when said vehicle is accelerated from a position of rest up to a predetermined speed, and subsequently cut out of power from said electrical propulsion means when said predetermined speed has been exceeded.

3. The improvement of claim 2 wherein said electrical propulsion means comprises first and second electrical motors, each of said electrical motors being operatively coupled to a respective one of said second set of driving wheels.

4. The improvement of claim 3 wherein said second set of driving wheels comprises rear wheels of said vehicle.

5. The improvement of claim 2 wherein said batteries are operative to drive all accessories associated with the vehicle.

6. In a vehicle having a frame, a body secured to said frame, propulsion means, a front axle having wheels mounted thereon, the improvement wherein there is provided a rear section connected to said frame, said rear section comprising a rear axle, wheels mounted on said rear axle, a platform mounted on said axle, said platform having a weight distribution whereby greater than 50% of the weight of said platform is located rearwardly of said rear axle.

7. The vehicle of claim 6 wherein said vehicle includes electric propulsion means, said electric propulsion means including a plurality of batteries, said batteries being mounted on said platform.

8. The vehicle of claim 7 wherein said platform has a longitudinal axis extending from a front of said platform to a rear thereof, said longitudinal axis forming an angle with respect to horizontal of between 15° and 17°

9. The vehicle of claim 7 wherein said platform has a weight distribution whereby the total difference between weight forward of said axle and a rear weight rearward of said axle is between 100 pounds and 400 pounds.

10. The vehicle of claim 1 wherein said vehicle further includes an internal combustion engine, said vehicle being a hybrid vehicle.
